(19) United States
(12) Patent Application Publication
(10) Pub. No.: US 2005/0210274 A1
(43) Pub. Date: Sep. 22, 2005

(54) Apparatus and method for intellectual property protection using the microprocessor serial number

(76) Inventor: Gene A. Frantz, SugarLand, TX (US)

Correspondence Address: TEXAS INSTRUMENTS INCORPORATED, P O BOX 655474, M/S 3999, DALLAS, TX, 75265, US

(21) Appl. No.: 10/805,776

(22) Filed: Mar. 22, 2004

(51) Int. Cl. H04L 9/00

(52) U.S. Cl. 713/189

(57) ABSTRACT

In order to prevent unauthorized usage of a software program, the software program is encrypted using at least a part of a serial number or other identifying number stored in the processing unit as the encryption key. The software program is stored in encrypted form in the processing unit memory. When the processing unit requires the use of the software program, the program is encrypted using the internally stored serial or identifying number.

### FIELD OF THE INVENTION

This invention relates generally to microprocessors and, more particularly, to the protection of intellectual property such as software programs that are executed by the microprocessors.

### BACKGROUND OF THE INVENTION

As microprocessors have increased in speed of execution of instructions, the need for timely program execution implemented in the design of the processor itself, has diminished. The program execution functionality can therefore be implemented in software rather than in the hardware implementation. The placement of increasing amount of intellectual property content in the software programming has the advantage of flexibility in the ability to change and/or update the operation of a data processing unit. However, the placement of increasing amounts of intellectual property in the software programs has made the protection of the software program increasingly important.

While software programs are usually provided under license and/or under copyright, the protection of software by contractual methods and/or copyright has proven largely been effectual. The ease of copying software program has lead to wide-spread violation of the intellectual property rights. Encryption methods have provided some relief when the encryption procedure and the encryption key can be separately provided to the user. Aside from the practical problem of trying to provide a decryption procedure and a decryption key to the user in manner to that is convenient for the user and difficult for a potential thief, once the procedure is determined by a potential thief, the entire data processing unit base is then open to comprise.

A need has therefore been felt for apparatus and an associated method to protect the intellectual property in a software program. It would be yet another feature of the apparatus and associated method to couple a software program with a processor or group of processors. It is a more particular feature of the apparatus and associated to provide an encrypted software program using an encryption key associated with the processing unit to be used in executing the software program. It is a still more particular feature of the apparatus and associated method that at least a portion of the encryption key of an encrypted software program is derived from an identifying number stored in the processing unit that is to execute the software program. It is yet a more particular feature of the apparatus and associated method to provide an encryption key based on the serial number of a data processing system.

### SUMMARY OF THE INVENTION

The aforementioned and other features are accomplished, according to the present invention, by providing each processor with an identifying/serial number. The identifying/serial number is stored in a protected memory accessible only to the associated processor. For at least selected software programs to be executed by the processor, each software program is encrypted using at least a portion of the identifying/serial number of the processor on which the program is to be executed as the decryption key. The encrypted software programs can be stored in the processor memory unit or external to the processor. When the software program is executed by the processor, the decryption procedure and the identifying/serial number are accessed by the processor and used to decode the decrypted software program. The processor then executes the decrypted software program.

Other features and advantages of the present invention will be more clearly understood upon reading of the following description and the accompanying drawings and claims.

### BRIEF DESCRIPTION OF THE DRAWINGS

FIG. 1 is block diagram of illustrating the relationship of an encrypted software program to the processing unit according to the present invention.

FIG. 2 is flow chart illustrating the execution of an encrypted software program according to the present invention.

### DESCRIPTION OF THE PREFERRED EMBODIMENT

1. Detailed Description of the Drawings

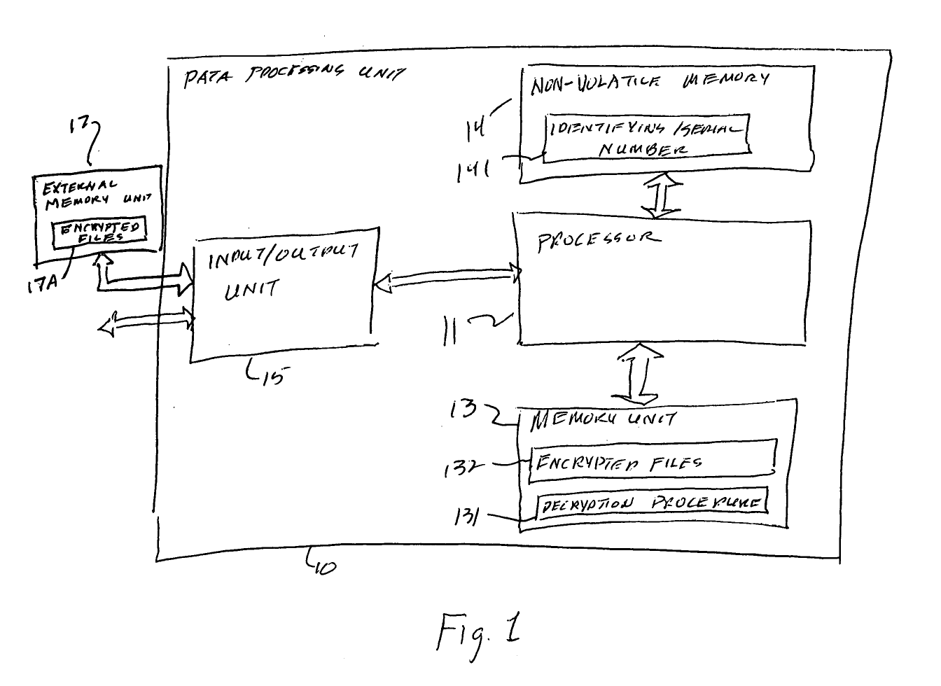

Referring to FIG. 1, the relationship of an encrypted software program to the processing unit upon which software program will be executed is shown according to the present invention. A data processing unit 10 includes an input/output unit 15 for exchanging data, program, and control signals between external apparatus and the processor 11. (As will be clear to those skilled in the art, the architecture of a data processing unit is typically more complicated than this discussion would indicate. For example, a direct memory access unit can transfer signals between the input/output unit 15 and the memory unit 13 without accessing the processor 11.) The processor 11 exchanges signal with the input/output unit 15, a memory unit 13 and a non-volatile memory unit 14. The memory unit typically includes the decryption program 131 and encrypted files 132. The protected, non-volatile memory 14 can store the identifying/serial number 141. Or the identifying/serial number can be hard-wired in the apparatus associated with processor 11. The identifying/serial number is accessible only to the data processing unit 10 with which it is associated. In addition, encrypted files 17A can be stored in an external memory unit 17 and applied to the processor 11.

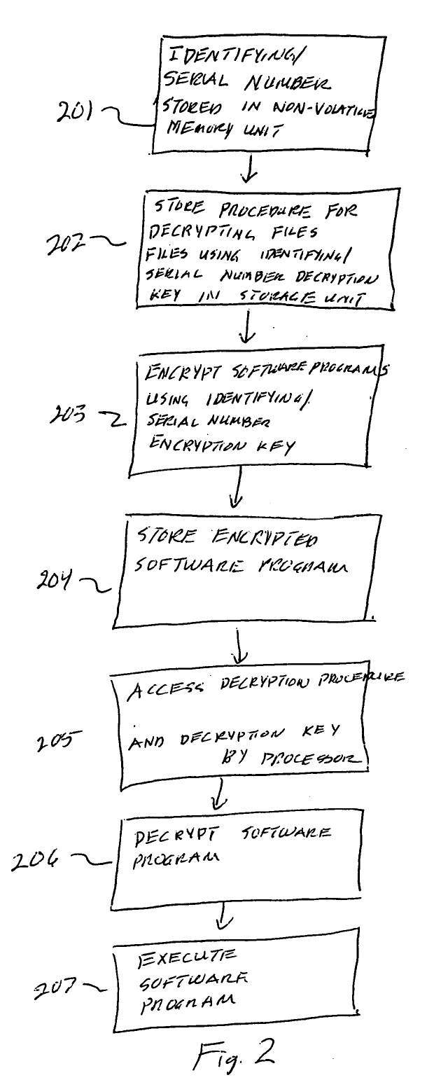

Referring to FIG. 2, the procedure for implementation of providing a secure software program protocol according to the present invention. In step 201, an identifying/serial number is stored in a non-volatile memory in the data processing unit. The identifying/serial number can be hard-wired in the data processing unit integrated circuit according to one embodiment. In the memory unit 13, a decryption procedure that operates using at least a portion of the identifying/serial number as an encryption key is stored in the memory unit 13 in step 202. In step 203, a software program is encrypted using the encryption procedure related to the decryption procedure of step 202. The encryption procedure uses the identifying/serial number as the encryption key. The encrypted software program is stored in the memory unit 13 in step 204. In step 205, in response to program requirements in the data processing unit 10, the decryption procedure, the encryption key and a selected encrypted program is transferred to the processor 11. The processor 11 then converts the encrypted program into executable text. In step 207, the processor 11 executes the decrypted software program.

2. Operation of the Preferred Embodiment

The present invention couples an encrypted software program with a processor or group of processors upon which the software program is to be executed. The coupling is accomplished by providing a microprocessor or group of microprocessors with an identifying/serial number. A software program is encrypted using at least at least a portion of the identifying/serial number as a key. The identifying/serial number is typically “hard-wired” in the microprocessor, but can be stored in a secure, non-volatile memory such as flash memory accessible only by the associated processor. In this manner, the software program can be used/decrypted only when the encryption of the software program is performed with the identifying/serial number. This procedure has the advantage that the encrypted program can not be shared with another data processing unit. In addition, if the procedure were pirated, the procedure would be traceable to a specific device.

While the embodiment of the invention discussed above involved an encrypted software program being stored in the memory unit, it will be clear that the encrypted program can be stored in a location external to the data processing unit. The encrypted software program from an external program can be decrypted on the fly or block by block, or completely decrypted and the decrypted portion of the program stored in a protected memory unit accessible only to the associated processor. Similarly, the decrypted program can be executed on the fly or stored in a protected, internal memory for latter use either block by block or in its entirety.

The identifying/serial number is typically included in an integrated circuit processor. This identifier/serial number is typically used to provide information to the manufacturer in the event that the integrated circuit is defective. The identifier, that is typically associated with the date and parameters of the circuit parameter can be used to determine whether the defect is a result of the process itself or arises from some random factor. As will be clear, a plurality of processing units can have the same serial number or identifying number assigned thereto.

One technique for using the present invention is for the manufacture/agent to have a list of identifying/serial numbers associated with the identity of the user of the target processor. In this manner, the manufacturer/agent can customize the encryption of files for the requesting user. A further level of security can e achieved by storing the identifying/serial numbers in a file addressed by a user identification, but capable of being accessed only by the encrypting apparatus.

While the invention has been described with respect to the embodiments set forth above, the invention is not necessarily limited to these embodiments. Accordingly, other embodiment variations, and improvements not described herein, are not necessarily excluded from the scope of the invention, the scope of the invention being defined by the following claims.

1. A data processing unit for executing an encrypted software program, the data processing unit comprising:
a processor for decrypting the encrypted software program and for executing software program, the processor including an identifying number; and
a memory unit, the memory unit storing the decryption procedure the encrypted program being encrypted using at least a portion of the identifying number;
wherein, when the processor is to execute the software program, the software program is decrypted using the at least a portion of the identifying number.

2. The data processing unit as recited in claim 1 wherein the encrypted software program is stored in the memory unit.

3. The data processing unit as recited in claim 1 further comprising an external memory unit, wherein the encrypted software program is stored in an external memory unit.

4. The data processing unit as recited in claim 1 wherein the identifying number is a serial number.

5. The data processing unit as recited in claim 1 wherein the identifying number is associated with a plurality of data processing units.

6. A method for protecting software programs, the method comprising:
providing a data processing unit with an identifying number;
encrypting a software program external to the data processing unit using at least a portion of the identifying number; and
decrypting the encrypted software program prior for execution of the software program by the data processing unit.

7. The method as recited in claim 6 further comprising the step of storing the identifying number in non-volatile memory unit accessible to the data processing unit.

8. The method as recited in claim 7 wherein the identifying number is a serial number for the data processing unit.

9. The method as recited in claim 7 wherein the encrypted software program is stored external to the data processing unit.

10. The method as recited in claim 7 wherein the encrypted program is stored in data processing unit.

11. A data processing system, the system comprising:
a data processing unit, the data processing unit including an identifying number stored therein; and
a decryption unit, the decryption unit decrypting software programs using a decryption key based on the identifying number;
wherein the data processing unit decodes an encrypted software program applied thereto using the decryption key.

12. The system as recited in claim 11 wherein the identifying number is the data processing unit serial number.

13. The system as recited in claim 11 further comprising a memory unit external to the data processing unit, the memory unit storing encrypted software programs.

14. The system as recited in claim 11 further comprising a memory unit in the data processing unit, the memory unit storing encrypted software programs.

15. The system as recited in claim 11 wherein an encrypted program is decrypted as an entity or on the fly prior to execution of the software program by the data processing unit.

16. The system as recited in claim 11 wherein the encrypted program is stored external to the data processing unit.

17. The system as recited in claim 11 wherein an encrypted program is stored in the data processing unit.

18. The system as recited in claim 15 wherein decrypted portions of the software program are stored in a protected memory unit accessible to only the associated data processing unit.

19. The method for protecting a software file, the method comprising:
providing a target processor having an identifying/serial number accessible only to the target processor;
encrypting the software file using at least a portion of the identifying/serial number; and
applying the encrypted software file to the target processor.

20. The method as recited in claim 19 further comprising, in the target processor, decrypting the encrypted software file based on the identifying serial number.

21. An apparatus for secure transfer of software files, the apparatus comprising:
a first processor, the first processor having a program for encrypting a software file; and
a second processor, the second processor having a program for decrypting software files using at least a portion of an identifying/serial number stored in the second processor, the stored identifying/serial number accessible only to the target processor;
wherein the first processor encrypts the software file using a copy of the at least a portion of the identifying/serial number.

22. The apparatus as recited in claim 21 wherein the copy of the at least a portion of the identifying/serial number is accessible only to the first processor.

23. The apparatus as recited in claim 22 wherein the at least a portion of the identifying/serial number is accessed by the first processor based on an indicia of the second processor.

24. The apparatus as recited in claim 21 wherein an encrypted software file is stored in an unsecured storage unit.

25. The apparatus as recited in claim 21 wherein the encrypted software file is stored in an unsecured storage unit prior to decryption.
